(19) United States
(12) Patent Application Publication
(10) Pub. No.: US 2023/0213831 A1
(43) Pub. Date: Jul. 6, 2023

(54) WATER-BASED-ORGANIC ELECTROLYTE ELECTROCHROMIC DEVICES WITH LOWER POWER CONSUMPTION AND IMPROVED CYCLABILITY

(71) Applicant: UNIVERSITY OF SOUTH FLORIDA, Tampa, FL (US)

(72) Inventors: Elias K. STEFANAKOS, Dover, FL (US); Sharan Kumar INDRAKAR, Tampa, FL (US); Arash TAKSHI, Tampa, FL (US)

(21) Appl. No.: 18/040,867

(22) PCT Filed: Aug. 9, 2021
(86) PCT No.: PCT/US2021/045246

§ 371 Date: Feb. 7, 2023

Related U.S. Application Data
(60) Provisional application No. 63/064,739, filed on Aug. 12, 2020.

(51) Int. Cl. G02F 1/1523; G02F 1/155

(52) U.S. Cl. CPC G02F 1/1525; G02F 1/155; G02F 2001/164

(57) ABSTRACT

The use of materially-asymmetric electrodes in an electro-chromic (EC) cell having a single active layer that employs a water-based gel electrolytic material solves a problem that is exhibited during operation of conventionally-structured devices and that is caused by electrolysis of water in the gel and formation of gas bubbles inside the conventionally-structured devices, thereby substantially increasing the number of operational cycles such devices can be subjected to.

### CROSS-REFERENCE TO RELATED APPLICATIONS

This patent application claims priority from and benefit of the U.S. Provisional Patent Application No. 63/064,739 filed on Aug. 12, 2020. The disclosure of the above-identified patent application is incorporated herein by reference.

### RELATED ART

Electrochromic devices are devices the optical properties or state of which (such as light transmission and absorption, for example) can be altered in a reversible manner through the application of a voltage. This property enables electrochromic devices to be used in various applications, such as smart windows, electrochromic mirrors, and electrochromic display devices, to name just a few.

Most commercially available electrochromic devices are relatively complex in that such devices require multiple layers of materials, in order for the device to change its operational state. As an example, some electrochromic devices may include a structure with a layer of conductive glass, a layer of a metal oxide, an electrochromic layer, an ionic electrolyte layer, and a further layer of conductive glass. When an electrical potential is applied to such a device, an electrochemical reaction occurs at the interface of the two active layers (i.e., the electrochromic layer and the electrolyte layer), which reaction changes the redox state of a polymer contained in the electrochromic layer, thereby changing the color of the electrochromic layer. At the same time, the electrochromic devices are known to often have limited use because of power consumption demands and the deterioration of the components of the electrochromic device over time. In view of this, it would be desirable to have electrochromic devices with lower power consumption and longer operational use.

### SUMMARY

Embodiments of the invention provide an electrochromic device with materially-asymmetric electrodes, in which a first electrode is made of a first material characterized by a first work function, a second electrode is made of a second material characterized by a second work function that is different from the first work function; and in which a composite gel material disposed between and in electrical contact with the first electrode and the second electrode. Here, the composite gel material is configured to change a visually-perceived color of the composite gel material when a difference of potentials is applied between the first electrode and the second electrode. In one implementation, such a device satisfies the following structural conditions: the composite gel material is a water-based gel material, and/or the composite gel material is fluidly sealed in an electrochromic cell from an ambient environment (here, the electrochromic cell is defined by the first electrode, the second electrode, and a peripheral seal layer disposed to circumscribe the composite gel material in a gap between the first and second electrodes), and/or the composite gel material is the only material layer in said EC cell. Alternatively or in addition, and in substantially any implementation, the device may be configured to achieve a substantially opaque state when a level of voltage applied between the first and second electrodes is necessarily smaller than 1.23 V. Alternatively or in addition, and in substantially any implementation of the device, the device may be configured to have a range of a value of electric potential between a reduction potential of the composite gel material and an oxidation potential of the composite gel material to be smaller than 1 V. Alternatively or in addition, and in substantially any implementation, the composite gel material may include at least one of polyvinyl alcohol, hydrochloric acid, an oxidant, and a conducting polymer (and, in at least one specific case, comprise an inorganic gel material). In at least one case, the first electrode of the device includes fluorine doped tin oxide, while the second electrode includes a glass layer and a film layer (of at least one of doped SnO₂, ZnO, WO₃, and TiO) carried thereon; and/or a conducting polymer layer characterized by the second work function that is adjustable by varying a density of doping of the conducting polymer layer with a chosen dopant; and/or a transparent substrate and a layer of metal nanowires; and/or a metal oxide.

Embodiments additionally provide a method for fabricating an electrochromic device structured according to one of the above-identified implementation, where the method includes the steps of disposing the first electrode made of the first material characterized with the first work function in electrical contact with said gel material; and positioning the second electrode made of the second material characterized with the second work function in electrical contact with said gel material such as to sandwich the gel material between the first electrode and the second electrode. In at least one specific case, the method additionally includes a step of electrically connecting the first and second electrodes to respectively-corresponding electrical leads of electrical circuitry that is configured to generate the a voltage having a value variable within a range substantially defined by an oxidation potential of said gel material and a reduction potential of the gel material. (In at least one specific case, the maximum value of such voltage does not exceed 1.23V.) Alternatively or in addition, and in substantially any implementation, such range is defined by a sum of an absolute value of the reduction potential and an absolute value of the oxidation potential and does not exceed 2.4 V, or 1.5V, or preferably 1.0V.

Embodiments further provide a method for operating an electrochromic device configured according to one of the above-identified implementations, which method includes a step of switching an operational state of such electrochromic device from transparent to substantially opaque or from substantially opaque to transparent by applying a difference of potentials to the first and second electrodes, wherein an absolute value of such difference does not exceed 1.23V; and/or repeating such switching at least 10,000 times (preferably, at least 10⁵ times, even more preferably at least 10⁶ times, and most preferably at least 10⁷ times, depending on the specifics of a particular implementation) without carrying a process of electrolysis of water in said gel; and/or repeating such switching without producing bubbles of gas in the gel even after the switching has been repeated at least 10,000 times (preferably, at least 10⁵ times, even more preferably at least 10⁶ times, and most preferably at least 10⁷ times, depending on the specifics of a particular implementation).

Embodiments additionally provide a method for reducing both a value of current and a value of voltage at which a water-based composite gel electrolytic layer of an electrochromic device is substantially oxidized during an operation of the device. Such method includes a step of providing direct mechanical contact and direct electrical contact between such gel layer and a first electrode of the device and a second electrode of the device during the process of the assembly or structuring of the device. Here, the first and second electrodes are made of materials with different work functions and sandwich the gel layer therebetween

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A is a schematic of an electrochromic device structured as a single gel-layer containing device.

FIG. 1B is an image including three-sub-images each of which illustrates the device (fabricated according to an embodiment of the invention) at different biasing conditions.

FIG. 2A is an image illustrating a tested electrochromic device (structured conventionally, in a materially-symmetric fashion) in which bubbles trapped inside the gel after applying 2.0 V, for a period of time, can be observed.

FIG. 2B is a schematic of an electrochromic device with materially-asymmetric electrodes, configured according to an embodiment described herein.

FIG. 3A is a graph presenting the results of cyclic voltammetry measurements performed with a first electrochromic device with a first set of electrodes, according to an embodiment described herein.

FIG. 3B is a graph illustrating the results of cyclic voltammetry measurements of a second electrochromic device with a second set of electrodes that are different from those of the embodiment of FIG. 3A.

FIGS. 4A1, 4A2 illustrate structural details of one embodiment of the device of the invention while, at the same time, schematically showing physical changes (cyclical change of optical density of the EC layer) occurring as a result of reduction and oxidization of the EC layer.

FIGS. 4B1, 4B2 illustrate structural details of a conventionally-configured EC device while, at the same time, schematically showing physical changes (cyclical change of optical density of the EC layer) occurring as a result of reduction and oxidization of the EC layer.

Generally, the sizes and relative scales of elements in Drawings may be set to be different from actual ones to appropriately facilitate simplicity, clarity, and understanding of the Drawings. For the same reason, not all elements present on one Drawing may necessarily be shown in another.

### DETAILED DESCRIPTION

The present disclosure of embodiments relates to improving the power consumption and cyclability of an electrochromic device.

Embodiments of the present invention solve major problems that manifest in operation of a single active layer electrochromic (EC) device that employs a water-based gel electrolytic layer. Specifically, embodiments of the present invention address the problem of high-energy consumption of the device (especially pronounced when the device is operated in a continuous DC power mode); the deterioration of the device caused by electrolysis of water in the gel and the formation of gas bubbles inside the device (especially pronounced when the device is operated at the oxidation potential—that is, when the device is being substantially opaque, highly optically absorbing, substantially impenetrable to visible light); and the following reduction of number of operating cycles (that is, shortening of lifetime) and the failure caused by such bubbles.

The solution(s) to the above-identified problems are provided by utilizing, in an embodiment of the device of the invention, electrodes that are characterized by different work functions that facilitate the reduction of the operational voltage of the device (and in at least one case, the reduction of such voltage to a level below 1.23 V).

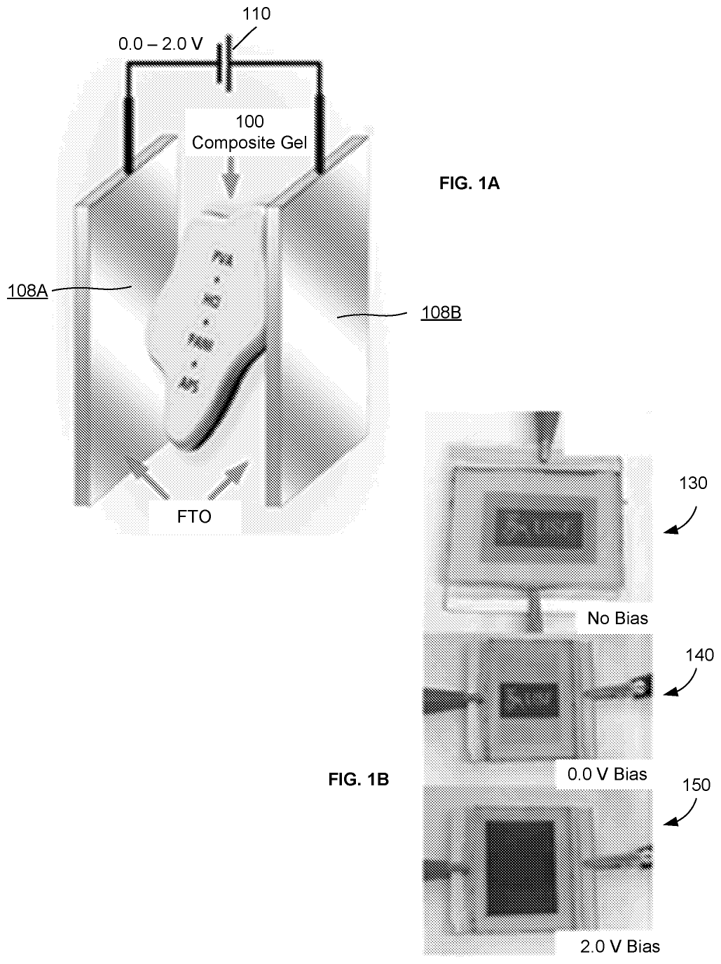

Recently developed technology for electrochromic (EC) devices utilizes a single layer of 104 a redox-active composite gel material that is sandwiched or positioned between electrically-conducting fluorine-doped tin oxide (FTO) glass substrates or plates 108A, 108B, as shown in FIG. 1A. A typical EC device works on and changes its optical properties (or state of operation) as a result of application of an external voltage, 110. The composite gel can be made of various materials. In one non-limiting example, a composite gel can be procured by mixing polyvinyl alcohol (PVA), hydrochloric acid (HCl), an oxidant (e.g. ammonium perdisulphate-APS), a conducting polymer (e.g. polyaniline, PANI, or polypyrrole, PPy), and with or without a dye material (e.g. methylene blue, MB; methylene orange, MO; etc.) in water.

As is well known in the art, when driven by different bias voltage the conventional EC device will change its optical density (and often the associated color of the gel material in the EC cell of the device). To this end, FIG. 1B presents three images, side-by-side, in which operational states of given EC device are illustrated at different levels of applied voltage bias. Here, the sub-image 130 refers to a scenario in which the EC device is still virgin in that it has not undergone any cycles of operation (˜ shown in an open circuit) and has had no bias being applied, with the result that the composite gel layer is visually perceived as being greenish. At 140, the same EC device has been worked through at least some cycles of operation and, as shown, is biased with 0.0 V (short-circuited, effectively), with the composite gel rendering a yellow color. The sub-image 150 reflects the situation in which the EC device is biased at 2.0 V, to substantially completely “darken” the device, turn it into an opaque mode”, and render such device to assume the lowest possible (preferably, substantially zero) transmittance at a wavelength of interest.

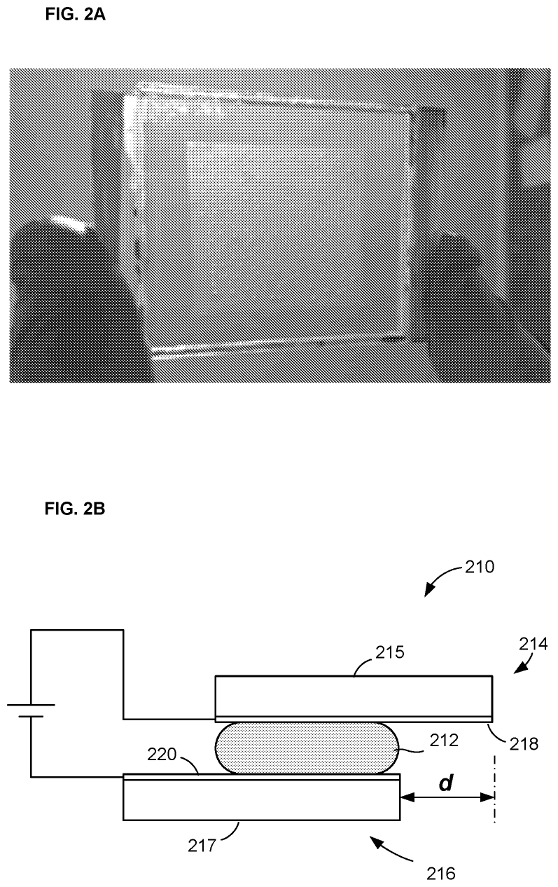

While the simplicity and low-cost production of a single-layer gel based electrochromic device are promising for widespread applications in smart windows and displays, the relatively large difference of potentials (i.e. 1.5-2.0 V) that is required to change the color of the electrolytic gel and the optical density of the device drives the relatively high-power consumption for these devices. More importantly, however, since such gel material 100 typically contains water, the application of voltage higher than about 1.23 V can electrolyze the water contained in such gel thereby causing the generation of hydrogen and oxygen and the formation of bubbles inside the gel layer, as shown in FIG. 2A. As a person of skill in the art will readily appreciate, the water electrolysis process is non-reversible and, in the case of the subject EC devices continue to deteriorate the gel layer as the number of operational cycles of the device (that is, changes between the opaque mode of operation and the transparent mode of operation) increases, eventually rendering the EC device inoperable for intended purpose.

With reference to FIG. 2B, shown is a schematic of an embodiment of an EC device 210 according to the idea of the invention. The EC device 210 comprises a single active layer of composite gel material, or “active layer,” 212 that is positioned (e.g., sandwiched) between the first electrode 214 and the second electrode 216. For the purposes of this disclosure and the appended claims, the composite gel-like active layer 212 is understood to be both structurally and compositionally different from the solid layer of the polymer-based electrolyte (discussed, for example, in U.S. Pat. No. 10,739,620, the disclosure of which is incorporated by reference herein) and, as a result, a structure of an embodiment of the device illustrated in FIG. 2B is principally different from the solid touchchromic device discussed in U.S. Pat. No. 10,739,620.

For the purposes of this disclosure, a gel material is distinguished from a solid materials at least in part with respect to the process of fabrication of a device containing such a material. A process of deposition of a solid material in a form of a layer, for example, requires a thin-film coating methodology such as evaporation, sputtering, or electrochemical deposition, to name just a few. In advantageous contradistinction, a layer of a gel material can be fabricated by simply applying, smearing the gel material on one electrode like butter on bread and then juxtaposing the other electrode on top of the gel and pressing the two electrodes towards each other to achieve the desired gel thickness between the electrodes while using a spacer layer. The example of the process of assembly of an embodiment of the invention is discussed below in detail.

The first electrode 214 is preferably spatially-asymmetrically positioned with respect to the second electrode 216 (as indicated by a spatial offset d) to provide for some peripheral area of the corresponding electrode for proper juxtaposition of the electrical leads/contacts. The first electrode 214 and second electrode 216 can include, respectively, —corresponding transparent or translucent material layers 215 and 217 (for example, layers including glass or plastic material. The term “active” as used in connection with the active layer 212 of the embodiment 210 refers to and defines the fact that for operation of the device the operational state of such electrolytic layer is required to be reversibly changed. The transparent or translucent layers 215, 217 of the electrodes, on the other hand, are not subject to the change in the state of operation (and therefore are not “active” layers) but are instead provided to protect the active layer 212 and form a complete electrochromic cell, once gel is also fluidly sealed across its thickness and around its edge-surface between the electrodes. Accordingly, there are no layers of the device 210 between the material layers 215, 217 other than the single active layer 212 that contributes to the change of the operational state of the device.

In some embodiments (and this is illustrated in FIG. 2B), the first electrode 214 and the second electrode 216 can additionally but optionally incorporate transparent electrically-conductive coatings shown as 218, 220, with which the material layers 215, 217 are coated or which the layers 215, 217 contain or carry. Such electrically-conductive coatings 218, 220 may be formatted as films, and facilitate the application of electrical potentials to the active layer 212. The transparent, electrically conductive films 218, 220 can, in some embodiments, include a transparent conducting oxide (TCO), such as indium tin oxide (ITO), fluorine doped tin oxide (FTO), or doped zinc oxide (ZnO). Generally, and irrespective of the material composition of the transparent, electrically conductive films 218, 220, such films at least cover the surfaces of the layers 215, 217 that face the active layer 212.

Embodiments of the present disclosure address the above-noted problems of operation of the conventionally-structured EC devices employing a single water-containing gel-based electrolytic layer by offering a solution for making low voltage, low power, and long lifetime single layer gel-based EC devices. To this end, an EC cell structured according to the idea of the invention includes two different electrodes with different work functions in order to reduce the operational voltage of the device (and, at least in some instances, to reduce the operational voltage to less than 1.23 V).

In the context of the present disclosure, the term work function is defined according to a commonly-used definition accepted in related art and refers to the minimum thermodynamic work (i.e. energy) needed to remove an electron from a surface of a material into space immediately outside such surface.

According to the idea of the invention, electrodes of a given embodiment of the device are made or comprised of different materials characterized by different work functions. Such electrodes may be interchangeably referred to herein as materially-asymmetric electrodes (and the resulting device—as a materially-asymmetric device). For example, the first electrode 214 may of the EC cell of an embodiment of the invention may include FTO (which has a work function of about 4.5 eV) while the second electrode 216 may include a metal oxide, while in specific cases such second electrode may be made of a transparent metal oxide such as SnO₂, ZnO, WO₃, TiO, and other suitable transparent metal oxides. In one implementation, the electrodes of the EC cell are devised to be sufficiently different based on an absolute difference between respective work functions. For example, when the electrode 214 is made of FTO and the second electrode 216 is made of gold (which has a work function of about 5.1 eV), the difference between these two work functions amounts to about 0.6 eV.

In at least one implementation, the EC device is structured such that the materials chosen for the electrodes are subject to a requirement that a difference between the work functions needs to satisfy a pre-determined work-function-difference threshold, which leads to a corresponding reduction of the operational voltage for the so-implemented device. The difference in work functions defines by how much the voltage applied to the two electrode can be reduced to achieve switching between the operational states of the EC device. For example, the use of an FTO electrode and a gold electrode satisfies the requirements of the difference threshold to be of about 0.5 eV. In a related example, the difference threshold can be chosen as a voltage value greater than 0.3 eV. In another example, the difference threshold may be set in a range between 0.3 eV and 1.0 eV.

As previously noted, one advantage, among others, of the present embodiments is that it enables the EC devices to operate at lower operating voltages. For example, it is fairly common for the water-based gel of the EC device to turn from a transparent state to an opaque state when a voltage level is applied at about 1.5 V across the electrodes. In contrast, an embodiment of the device structured as discussed above is capable of changing the color of the composite gel layer from a transparent state to an opaque state at a voltage with a value of less than 1.23 V, and in a specific example with a value within a range from about 0.6V to about 1.0V. In some embodiments, and depending on the material used for one of the electrodes—Al, Zn, Au, etc—the level of operational voltage applied between the electrode required for changing the color of the composite gel from the transparent state to an opaque state is even lower, as evidenced by the empirical results discussed below. Generally, as a person of ordinary skill in the art will readily appreciate, embodiments of the device are configured to operate in the range between the oxidation potential of the gel material of the device and the reduction potential of such gel material.

A corollary result of structuring the electrodes of embodiment of the invention from materials with different work functions is that the cyclability of such EC device—that is, the ability to work through multiple cycles of operation—is greatly increased. As previously noted, the voltages with absolute values higher than 1.23 V can electrolyze water in the gel layer and generate hydrogen and oxygen bubbles inside the gel. By having operating voltages smaller than 1.23 V (in terms of absolute values), the embodiments reduce the instances in which water electrolysis occurs, which thereby extends the operational life of the described EC device to at least 10,000 cycles or preferably more, depending on the specific embodiment and in clear contradistinction with the existing devices.

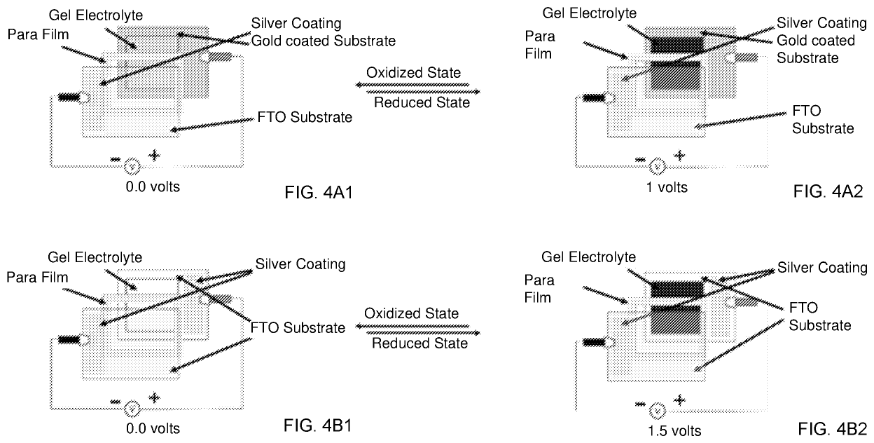

To this end, —and in reference to FIGS. 4A1 and 4A2—a process of assembly of an embodiment of FIG. 2B was carried out as follows. All the substrates were washed with DI water and ethanol for 10 mins. The substrates were cut to be about 1.5×1.5 cm in size, and the entire surface of one of the electrodes was coated with the composite gel while adding a parafilm peripheral frame with thickness of about 130 μm, around the body of such gel, as a separator or spacer. Then, the substrates were pressed together with the binder clips and later glued with the epoxy glue in all four directions, around the periphery of the so-formed EC cell, and dried at room temperature for 8 hours before the tests. The electrode substrate containing Au (or another non-FTO material, in different implementations) was connected to the positive terminal, and the FTO containing electrode was connected to the negative terminal. In contradistinction, the embodiment conventionally utilizing two FTO electrodes would be connected either way as shown schematically in FIGS. 4B1 and 4B2.

Once an embodiment of the EC device has been formed according to the idea of the invention, the device is operated by cycling the voltage applied between the two electrodes of the EC cell of the device. Here, the state of the water-base gel material layer is changed from a transparent state to a substantially opaque state by applying a difference of potentials between the first electrode and the second electrode in the range from about −1.2 V to about +1.2 V, preferably from about −0.5 B to about +1.0 V, and even more preferably between about −0.2 V and +0.75V. It is appreciated that in these cases, respectively-corresponding ranges of electric potential varied between a reduction potential of the composite gel material and an oxidation potential of the composite gel material does not exceed 2.4 V, preferably does not exceed 1.5 V, and is smaller than 1 V (and, specifically, about 0.95 V).

In the transparent state of the gel material, the gel may assume multiple color states where the specific colorization of the water-based gel defines the amount and spectral properties of light that can be transmitted through the water-based gel. For example, in FIG. 1B, reference number 130 illustrates the water-based gel displaying a green color, and reference number 140 illustrates a yellow color.

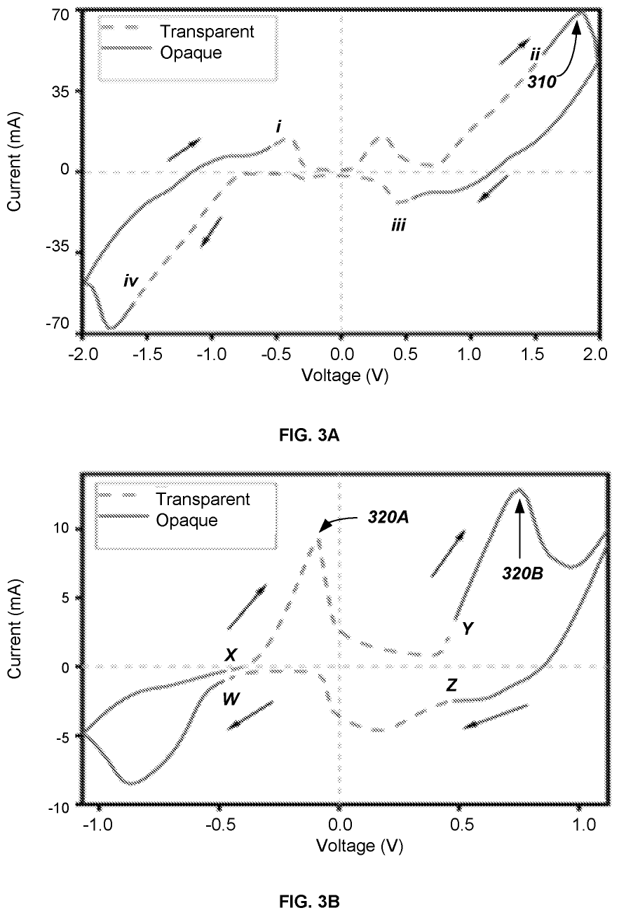

Empirical results presented in FIGS. 3A and 3B illustrate the feasibility of practically reducing the level of operational voltage (and, accordingly, the range of change of voltage required for switching between the substantially opaque and transparent operational states of an embodiment of the invention) in a single composite electrolytic gel-layer device generally structured according to the embodiment of FIG. 2B. To this end, FIG. 3A is a graph representing results of cyclic voltammetry measurements performed on a first electrochromic device with a first set of electrodes each of which was conventionally made from the FTO. The electrolytic gel layer of approximately 130 micron and including (PVA+HCl+PANI+APS), was disposed between and in electrical contact with the first electrode and the second electrode and substantially fluidly sealed around the perimeter of the gel layer to complete the EC cell (as discussed above in reference to FIG. 2B).

FIG. 3B, on the other hand, presents a graph of results of cyclic voltammetry measurements carried with the use of a second electrochromic device that is configured substantially identically to that represented by FIG. 3A but—in accord with the idea of the invention—in which a second set of electrodes is used that are different from those of the device corresponding to FIG. 3A in that the work functions of the materials of these electrodes necessarily differed from one another. Specifically, the second set of electrodes had one electrode of FTO and the other that included platinum (Pt; with a work function of about 5.6 eV).

In both FIG. 3A and FIG. 3B, a corresponding loop representing the direction of change of operational parameters is marked with arrows, and operational points at which the corresponding EC device turned from transparent to opaque or from opaque to transparent (that is, completely changed the corresponding operational status) is shown as points of stitching between the dashed and solid lines. For example, as shown for the embodiment of device of FIG. 3A, the switch between the opaque and transparent operational states with increase of applied voltage occurred at about (in the vicinity of) −0.5V or 0.6V and at about or slightly higher than 1.5 V (points, i and ii, respectively), while when operating in reverse—that is, with decrease of the applied voltage—the same change between the states of operation occurred at about 0.5V and at or slightly below −1.5V (points iii and iv, respectively). It can be seen that the substantially complete oxidation of the gel-like electrolytic layer occurred at about 1.75 . . . 1.8 V (illustrated as point 310). The absolute value of the current level during the cycling operation of the device of FIG. 3A was about 70 mA.

In advantageous contradistinctions with the results of FIG. 3A, the embodiment of the materially-asymmetric device (that is, the device in which the electrodes were made from materials with different work functions, here FTO and Pt as discussed above), demonstrated not only the reduction of a level of operational voltage required for switching between the substantially transparent and substantially opaque modes of operation of the device (this time, corresponding to points w, z and x, y, representing respectively the voltage levels of about −0.5V and about +0.5V), but also the reduction of peak current as compared with that of FIG. 3A. The embodiment of the materially-asymmetric EC device structured according to the idea of the invention was configured to operate within the range of voltage values between the oxidation potential of the water-based gel layer thereof and the reduction potential of such layer. As evidenced by FIG. 3B, such range is approximately between the point 320A (at about 0.2 V, corresponding to the reduction potential of the gel layer) and the point 320B (at about +0.75 or so, corresponding to the oxidation potential of the gel layer). The reduction of the peak current resulting from the use of a materially-asymmetric structure can be observed from about 70 mA (for the materially-symmetrical device of FIG. 3A, see point 310, corresponding to the operational point at which the gel layer 212 is substantially completely oxidized) to about 14 mA for the device of FIG. 3B, see point 320B). Notably, the reduction of absolute values of operational voltages required from switching between operational states of the device of FIG. 3B was also accompanied with establishing such levels to be substantially decoupled from whether the voltage applied to the device was being increased or decreased (unlike that demonstrated by the device of FIG. 3A).

A skilled artisan having the advantage of this disclosure will readily appreciate that, with the reduction of both the peak current and operational (switching) voltage, the power consumption of a materially-asymmetric embodiment of the device structured according to the idea of the invention is significantly lower than that of the device in which the two electrodes made of the same material (FTO, FIG. 3A). For practical applications, an electrode can be FTO with the work function of ˜4.5 eV and the other transparent electrode may alternatively include a glass substrate coated with a thin film of doped SnO2, ZnO, WO3, or TiO2, for example.

In at least one implementation, an electrode of the EC device may carry a coating configured as a thin film of a conducting polymer such as PEDOT:PSS, for example. Notably, in practice the work function of the electrode carrying a conducting polymer film can be adjusted by changing the doping density in such polymer film layer. (For example, in one non-limiting the case when each of the electrodes carries a corresponding conducting polymeric film—such as that including Poly(3,4-ethylenedioxythiophene) known as PEDOT, and/or Polypyrrole, and/or polythiophene. The doping density of such a polymer layer on one of the electrodes can be configured such that the resulting work function of this electrode differs from that of the other electrode. The doping density can be adjusted by various techniques, such as electrochemical processing, chemical processing, and other suitable methods. In one implementation of the present invention, for example, the doping density can be chosen as high as about 10e¹⁹ cm⁻³, while in a related implementation it can be defined to be as low as about 10e¹⁴ cm⁻³. In other implementations, the doping density of the subject polymer layer may be chosen to be between these two limits.)

In at least one non-exclusive implementation, the first electrode of the EC device is configured from FTO while the other is structured to carry a thin layer of metallic nanoparticles—for example, metal nanowires (NWs) such as Ag NWs (with the corresponding work function of about 4.5 eV to about 4.7 eV)—on a glass or a transparent plastic substrate.

A skilled artisan will readily appreciate that different features of related examples of non-exclusive embodiments discussed above can be combined and/or mixed in different fashions. For example, a set electrodes of a given EC device embodiment may include a thin layer of metal nanoparticles and/or an electrically-conducting substantially-transparent polymeric film (of a material allowing for different levels of doping such as to change the work function of the resulting polymeric film) and/or contain a metal oxide and/or contain FTO and/or be structured to have the opposing electrodes be spatially off-set with respect to one another.

For the purposes of this disclosure and the appended claims, the use of the terms “substantially”, “approximately”, “about” and similar terms in reference to a descriptor of a value, element, property or characteristic at hand is intended to emphasize that the value, element, property, or characteristic referred to, while not necessarily being exactly as stated, would nevertheless be considered, for practical purposes, as stated by a person of skill in the art. These terms, as applied to a specified characteristic or quality descriptor means “mostly”, “mainly”, “considerably”, “by and large”, “essentially”, “to great or significant extent”, “largely but not necessarily wholly the same” such as to reasonably denote language of approximation and describe the specified characteristic or descriptor so that its scope would be understood by a person of ordinary skill in the art. In one specific case, the terms “approximately”, “substantially”, and “about”, when used in reference to a numerical value, represent a range of plus or minus 20% with respect to the specified value, more preferably plus or minus 10%, even more preferably plus or minus 5%, most preferably plus or minus 2% with respect to the specified value. As a non-limiting example, two values being “substantially equal” to one another implies that the difference between the two values may be within the range of +/−20% of the value itself, preferably within the +/−10% range of the value itself, more preferably within the range of +/−5% of the value itself, and even more preferably within the range of +/−2% or less of the value itself.

The use of these terms in describing a chosen characteristic or concept neither implies nor provides any basis for indefiniteness and for adding a numerical limitation to the specified characteristic or descriptor. As understood by a skilled artisan, the practical deviation of the exact value or characteristic of such value, element, or property from that stated falls and may vary within a numerical range defined by an experimental measurement error that is typical when using a measurement method accepted in the art for such purposes.

References made throughout this specification to “one embodiment,” “an embodiment,” “a related embodiment,” or similar language mean that a particular feature, structure, or characteristic described in connection with the referred to “embodiment” is included in at least one embodiment of the present invention. Thus, appearances of these phrases and terms may, but do not necessarily, refer to the same implementation. It is to be understood that no portion of disclosure, taken on its own and in possible connection with a figure, is intended to provide a complete description of all features of the invention.

It is also to be understood that no single drawing is intended to support a complete description of all features of the invention. In other words, a given drawing is generally descriptive of only some, and generally not all, features of the invention. A given drawing and an associated portion of the disclosure containing a description referencing such drawing do not, generally, contain all elements of a particular view or all features that can be presented is this view, for purposes of simplifying the given drawing and discussion, and to direct the discussion to particular elements that are featured in this drawing. A skilled artisan will recognize that the invention may possibly be practiced without one or more of the specific features, elements, components, structures, details, or characteristics, or with the use of other methods, components, materials, and so forth. Therefore, although a particular detail of an embodiment of the invention may not be necessarily shown in each and every drawing describing such embodiment, the presence of this detail in the drawing may be implied unless the context of the description requires otherwise. In other instances, well known structures, details, materials, or operations may be not shown in a given drawing or described in detail to avoid obscuring aspects of an embodiment of the invention that are being discussed.

While the invention is described through the above-described examples of embodiments, it will be understood by those of ordinary skill in the art that modifications to, and variations of, the illustrated embodiments may be made without departing from the inventive concepts disclosed herein. For example, depending on the specific implementation, the composite gel layer that is used in devices structured according to the idea of the invention may include Polymer (PVA)-Acid (HCl)-Conducting polymer (PANT)-Oxidant (APS). Alternatively, the polymer can be selected from polyvinyl alcohol (PVA), poly (vinyl acetate), poly (vinyl alcohol co-vinyl acetate), poly (methyl methacrylate) polyvinyl butyral, polyvinyl chloride and poly(vinyl nitrate). The acid used to create the composite gel to form an electrolyte can include Hydrochloric (HCl), Sulfuric acid (H₂SO₄), Hydrofluoric acid (HF), Nitric Acid (HNO₃), Oxalic acid (C₂H₂O₄), Citric acid (C₆H₈0₇), Formic acid (CH₂O₂), Acetic Acid (CH₃COOH) and mixtures thereof. Alternatively or in addition, the conducting polymer can include polycarbazole, polyaniline, polypyrrole, polyhexylthiophene, poly(ortho-anisidine) (POAS), poly(o-toluidine) (POT), poly(ethoxy-aniline) (POEA)). The Oxidant component can includes ammonium persulfate, Lithium chloride, manganese (III) acetylacetonate, sodium chlorate, potassium permanganate, permanganate compounds chlorite, chlorate, perchlorate, to name just a few.

Disclosed aspects, or portions of these aspects, may be combined in ways not listed above. Accordingly, the invention should not be viewed as being limited to the disclosed embodiment(s). The invention as recited in claims appended to this disclosure is intended to be assessed in light of the disclosure as a whole. Various changes in the details, steps and components that have been described may be made by those skilled in the art within the principles and scope of the invention.

What is claimed is:

1. An electrochromic device, comprising:
a first electrode made of a first material characterized by a first work function;
a second electrode made of a second material characterized by a second work function that is different from the first work function, wherein the second electrode comprises
(1a) a glass layer and a film layer carried thereon, the film layer that includes at least one of SnO₂, ZnO, WO₃, and TiO doped transparent layers; and/or
(1b) a conducting polymer layer characterized by the second work function that is adjustable by varying a density of doping of the conducting polymer layer with a chosen dopant; and/or
(1c) a transparent substrate and a layer of metal nanowires; and/or
(1d) a metal oxide;
and
a composite gel material disposed between and in electrical contact with the first electrode and the second electrode, wherein said composite gel material is configured to change a visually-perceived color of the composite gel material when a difference of potentials is applied between the first electrode and the second electrode.

2. The electrochromic device according to claim 1,
(2a) wherein the composite gel material is a water-based gel material, and/or
(2b) wherein the composite gel material is fluidly sealed in an electrochromic cell from an ambient environment,
wherein the electrochromic cell being defined by the first electrode, the second electrode, and a peripheral seal layer disposed to circumscribe the composite gel material in a gap between the first and second electrodes, and/or
(2c) the composite gel material is the only material layer in said EC cell.

3. The electrochromic device according to claim 1, configured to achieve a substantially opaque state when an absolute value of voltage applied between the first and second electrodes is necessarily smaller than 1.23 V.

4. The electrochromic device according to claim 1, wherein a range of a value of electric potential between a reduction potential of the composite gel material and an oxidation potential of the composite gel material is smaller than 1 V.

5. The electrochromic device according to claim 1, wherein the composite gel material comprises at least one of polyvinyl alcohol, hydrochloric acid, an oxidant, and a conducting polymer.

6. The electrochromic device according to claim 1, wherein the composite gel material comprises an inorganic gel material.

7. The electrochromic device according to claim 1, wherein the first electrode comprises fluorine doped tin oxide.

8. (canceled)

9. A method for fabricating an electrochromic device structured according to claim 1, the method comprising:
disposing the first electrode made of the first material characterized with the first work function in electrical contact with said gel material; and
positioning the second electrode made of the second material characterized with the second work function in electrical contact with said gel material such as to sandwich the gel material between the first electrode and the second electrode.

10. The method according to claim 9, further comprising electrically connecting the first and second electrodes to respectively-corresponding electrical leads of electrical circuitry, configured to generate a voltage having a value within a range substantially defined by an oxidation potential of said gel material and a reduction potential of said gel material.

11. The method according to claim 10, comprising applying said voltage between the first and second electrodes while not exceeding a maximum of absolute value of said voltage to be 1.23V.

12. The method according to claim 1, wherein said range is defined by a sum of an absolute value of the reduction potential and an absolute value of the oxidation potential and does not exceed 2.4 V, or 1.5V, or preferably 1.0V while an absolute value of said voltage does not exceed 1.23V.

13. A method for operating an electrochromic device configured according to claim 1, the method comprising:
switching an operational state of said electrochromic device from transparent to substantially opaque or from substantially opaque to transparent by applying a difference of potentials to the first and second electrodes, wherein an absolute value of said difference does not exceed 1.23V

14. The method according to claim 13, further comprising:
repeating said switching at least 10,000 times without carrying a process of electrolysis of water in said gel.

15. (canceled)

16. A method for reducing of both a value of current and a value of voltage at which a water-based composite gel electrolytic layer of an electrochromic device is substantially oxidized during an operation of the device, the method comprising:
in structuring said device, providing direct mechanical contact and direct electrical contact between said gel layer and a first electrode of the device and a second electrode of the device,
wherein the first and second electrodes sandwich said gel layer therebetween,
wherein materials of the first and second electrodes have different work functions, and
wherein the second electrode comprises
(16a) a glass layer and a film layer carried thereon, the film layer that includes at least one of SnO₂, ZnO, WO₃, and TiO doped transparent layers; and/or
(16b) a conducting polymer layer characterized by the second work function that is adjustable by varying a density of doping of the conducting polymer layer with a chosen dopant; and/or
(16c) a transparent substrate and a layer of metal nanowires; and/or
(16d) a metal oxide.
